(19) United States
(12) Patent Application Publication
(10) Pub. No.: US 2016/0245923 A1
(43) Pub. Date: Aug. 25, 2016

(54) GLOBAL NAVIGATION SATELLITE SYSTEM SUPERBAND PROCESSING DEVICE AND METHOD

(71) Applicant: HEMISPHERE GNSS INC., Scottsdale, AZ (US)

(72) Inventor: Bradley P. BADKE, Chandler, AZ (US)

(73) Assignee: HEMISPHERE GNSS INC., Scottsdale, AZ (US)

(21) Appl. No.: 14/581,247

(22) Filed: Dec. 23, 2014

Related U.S. Application Data
(63) Continuation-in-part of application No. 13/545,813, filed on Jul. 10, 2012, now abandoned.
Application No. 13/545,813 is a continuation-in-part of application No. 12/635,527, filed on Dec. 10, 2009, now Pat. No. 8,217,833.
(60) Provisional application No. 61/121,831, filed on Dec. 11, 2008.

(51) Int. Cl. G01S 19/32; G01S 19/36; G01S 19/37; G01S 19/33

(52) U.S. Cl. CPC G01S 19/32; G01S 19/33; G01S 19/36; G01S 19/37

(57) ABSTRACT

The disclosed global navigation satellite system (GNSS) devices and methods group GNSS satellite signals from different GNSS constellations, as well as other signals of interest, into sub-bands, also called ‘superbands’, by signal frequency for analog filtering and processing, and then further divides each superband for additional processing in the digital domain. Each superband is a frequency range that can include GNSS satellite signals from one, two, three, or more than three, GNSS constellations. Using multiple parallel processing channels allows multiple signal frequency bands that cover a wide bandwidth to be divided into narrower superbands for processing, which increases the processing abilities within the superbands and allows out-of-band interference between superbands to be eliminated. Thus the GNSS satellite signals are divided for processing according to frequency, not according to the originating GNSS satellite constellation.

### CROSS-REFERENCE TO RELATED APPLICATIONS

This application claims priority to U.S. patent application Ser. No. 13/545,813, filed Jul. 10, 2012; to U.S. patent application Ser. No. 12/635,527, filed Dec. 10, 2009, now U.S. Pat. No. 8,217,833, issued Jul. 10, 2012; and to U.S. Provisional Patent Application No. 61/121,831, filed Dec. 11, 2008, all of which are incorporated herein by reference.

### BACKGROUND OF THE INVENTION

1. Technical Field

Disclosed herein is a global navigation satellite system (GNSS) device, and more specifically a GNSS device for processing GNSS satellite signals from multiple GNSS constellations while mitigating interference from out-of band signals.

2. State of the Art

Global navigation satellite systems (GNSS) include the Global Positioning System (GPS), which was established by the United States government and employs a constellation of 24 or more satellites in well-defined orbits at an altitude of approximately 26,500 km. These satellites continually transmit microwave L-band radio signals in three frequency bands, centered at 1575.42 MHz, 1227.60 MHz and 1176.45 MHz, denoted as L1, L2 and L5 respectively. All GNSS signals include timing patterns relative to the satellite's onboard precision clock (which is kept synchronized by a ground station) as well as a navigation message giving the precise orbital positions of the satellites. GPS receivers process the radio signals, computing ranges to the GPS satellites, and by triangulating these ranges, the GPS receiver determines its position and its internal clock error. Different levels of accuracies can be achieved depending on the techniques employed.

GNSS also includes the satellite constellations corresponding to the Galileo (Europe) system, the GLObal NAvigation Satellite System (GLONASS, Russia), BeiDou (China), the Indian Regional Navigational Satellite System (IRNSS) and QZSS (Japan, proposed). Galileo will transmit signals centered at 1575.42 MHz, denoted L1 or E1, 1176.45 denoted E5a, 1207.14 MHz, denoted E5b, 1191.795 MHz, denoted E5 and 1278.75 MHz, denoted E6. GLONASS transmits groups of frequency division multiplexed signals centered approximately at 1602 MHz and 1246 MHz, denoted GL1 and GL2 respectively. QZSS will transmit signals centered at L1, L2, L5 and E6.

A GNSS receiver that receives and processes GNSS satellite signals from multiple constellations requires a wide bandwidth to accept the wide range of frequencies of the multiple types of GNSS satellite signals. GNSS receivers are highly sensitive devices designed to receive very weak signals transmitted by the source GNSS satellites. As the airwaves become more crowded due to the high demand for radio frequency (RF) signal spectra allocations, reception problems arise from signal interference. Continual improvements in the ability of GNSS receiver devices to mitigate interference from spectrally close signals are desirable.

Accordingly, what is needed is a GNSS device which efficiently receives and processes a wide range of GNSS satellite signal frequencies, and yet mitigates the effect of unwanted signals on the operation of the GNSS device.

### BRIEF DESCRIPTION OF THE DRAWINGS

FIG. 1 shows a simplified diagram of a GNSS receiver environment;

FIG. 2 shows a block diagram of an embodiment of a GNSS device;

FIG. 3 shows a block diagram of an embodiment of a GNSS analog signal processing circuit in the form of a down converter circuit;

FIG. 4 shows a block diagram of an embodiment of a GNSS device;

FIG. 5 shows a block diagram of an embodiment of a GNSS device;

FIG. 6 shows a block diagram of an embodiment of a GNSS analog signal conditioning circuit;

FIG. 7 shows a block diagram of an embodiment of a signal transmission path within a GNSS analog signal conditioning circuit;

FIG. 8 shows a block diagram of an embodiment of a GNSS digital signal conditioning circuit;

FIG. 9 shows a block diagram of an embodiment of a GNSS device;

FIG. 10 shows a block diagram of an embodiment of a GNSS analog signal conditioning circuit;

FIG. 11 illustrates method 500 of processing radio-frequency (RF) signals received by a GNSS device.

### DETAILED DESCRIPTION OF EMBODIMENTS OF THE INVENTION

As discussed above, disclosed herein is a global navigation satellite system (GNSS) device capable of efficient processing of multiple GNSS signal frequencies along with interference mitigation via a combination of analog and digital processing.

Disclosed are GNSS devices for capturing and processing GNSS satellite signals and other signals of interest. Also disclosed are methods of processing the GNSS satellite signals and other signals of interest. The disclosed GNSS devices are capable of capturing and processing GNSS satellite signals from more than one GNSS constellation simultaneously. The disclosed GNSS devices and methods group GNSS satellite signals from different GNSS constellations, as well as other signals of interest, into sub-bands, also called ‘superbands’, by frequency, for analog filtering and processing, and then further divides the superbands for additional processing in the digital domain. Each superband is a frequency range that can include GNSS satellite signals from one, two, three, or more than three, GNSS constellations. Using multiple parallel processing channels allows multiple signal frequency bands that cover a wide bandwidth to be divided into narrower superbands for processing. This increases the processing abilities within the superbands, and allows out-of-band interference between superbands to be eliminated. Thus, the GNSS satellite signals are divided for processing according to frequency, not according to the originating GNSS satellite constellation. Dividing the signal processing between the analog and digital domains provides increased processing flexibility and capabilities, while minimizing the size and power consumption of the GNSS device hardware. The disclosed GNSS devices are capable of performing precision signal processing on GNSS signals from multiple GNSS constellations, as well as other signals of interest, while mitigating the interference from other spectrally close signals that are not of interest.

The disclosed GNSS devices and methods disclose how other signals of interest can be captured and processed along with the GNSS satellite signals. Other signals of interest can be used by the GNSS device to provide GNSS correction services, remote control, remote configuration of GNSS devices, or other desired features and services that are not provided by GNSS satellite signals. These other signals of interest can be much higher power than GNSS satellite signals, and spectrally close to the GNSS satellite signals. Separating the other signals of interest from the GNSS satellite signals can be difficult because the other signals of interest, such as cellular telephone signals, for example, tend to saturate the GNSS processing circuits due to their high power. Thus, the disclosed GNSS devices both mitigate the influence of the high-powered and spectrally close RF signals of interest on the GNSS satellite signals, as well as capture the other RF signals of interest for use by the GNSS device.

Global navigation satellite systems (GNSS) are broadly defined to include the Global Positioning System (GPS), which was established by the United States government and employs a constellation of 24 or more satellites in well-defined orbits at an altitude of approximately 26,500 km. These satellites continually transmit microwave L-band radio signals in three frequency bands, centered at 1575.42 MHz, 1227.60 MHz and 1176.45 MHz, denoted as L1, L2 and L5 respectively. All GNSS signals include timing patterns relative to the satellite's onboard precision clock (which is kept synchronized by a ground station) as well as a navigation message giving the precise orbital positions of the satellites. GPS receivers process the radio signals, computing ranges to the GPS satellites, and by triangulating these ranges, the GPS receiver determines its position and its internal clock error. Different levels of accuracies can be achieved depending on the techniques employed.

GNSS also includes the satellite constellations corresponding to the Galileo (Europe) system, the GLObal NAvigation Satellite System (GLONASS, Russia), Beidou (China), the Indian Regional Navigational Satellite System (IRNSS) and QZSS (Japan, proposed). Galileo will transmit signals centered at 1575.42 MHz, denoted L1 or E1, 1176.45 denoted E5a, 1207.14 MHz, denoted E5b, 1191.795 MHz, denoted E5 and 1278.75 MHz, denoted E6. GLONASS transmits groups of frequency division multiplexed signals centered approximately at 1602 MHz and 1246 MHz, denoted GL1 and GL2 respectively. QZSS will transmit signals centered at L1, L2, L5 and E6. Table 1 provides an example of GNSS frequency channel allocations, which could be received and processed with the GNSS device herein disclosed.

GNSS receivers are highly sensitive devices designed to receive very weak signals transmitted by the source GNSS satellites. GNSS receivers process the radio frequency signals, computing ranges to the GNSS satellites, and by triangulating these ranges, the GNSS receiver determines its position and its internal clock error. Different levels of accuracies can be achieved depending on the observed signals used and the correction techniques employed. For example, accuracy within about 2 cm can be achieved using real-time kinematic (RTK) methods with single or dual-frequency (L1 and L2) receivers.

TABLE 1
GNSS System Center Frequencies and Bandwidth

| | F_{center} | Bandwidth |
|---|---|---|
| System (signal) | (MHz) | (MHz) |
| SBAS | 1575.42 | 24 |
| GPS (L1CA) | 1575.42 | 24.0 |
| GPS (L1C) | 1575.42 | 24.0 |
| GPS (L1P) | 1575.42 | 24.0 |
| GLONASS (GL1) | 1602.0 | 16 |
| Galileo (E1) | 1575.42 | 24.0 |
| GPS (L2P) | 1227.6 | 24.0 |
| GPS (L2C) | 1227.6 | 24.0 |
| GPS (L5) | 1176.45 | 24.0 |
| GLONASS (GL2) | 1246.0 | 16 |
| Galileo (E5a) | 1176.45 | 24.0 |
| Galileo (E5b) | 1207.14 | 24.0 |
| Galileo (E5ab) | 1191.795 | 51.15 |

RF signal frequency spectra allocations are highly regulated by the Federal Communications Commission (FCC) in the United States and by other agencies worldwide. As the airwaves become more crowded as a consequence of demand for RF signal spectra allocations, reception problems arise from signal interference. For example, the telecommunications industry has experienced significant growth and increasing wireless traffic levels. Wireless telecommunications via RF signals are becoming increasingly popular among telecommunications service subscribers. To accommodate such demand, telecommunications service providers, through their industry associations, commonly seek FCC allocations of more frequency spectra.

The interests of the telecommunications industry are sometimes adverse to that of other RF service providers. For example, GNSS service providers, including the U.S. Department of Defense with its Global Positioning System (GPS), are increasingly likely to encounter interference problems associated with nearby or spectrally-adjacent telecommunications bandwidth usage.

With the proliferation of GNSS signals at multiple carrier frequencies, as well as the increased presence of nearby interfering frequencies, it is beneficial for a GNSS device to optimize the distribution of signal processing across the analog and digital domains. Capturing and processing the complete GNSS spectrum would require a bandwidth of approximately 500 MHZ, and would result in excessive power consumption, as well as interference from unwanted signals within the wide band. Alternatively, analog filtering techniques could be used to capture each individual GNSS signal and process each signal optimally. This would result in a relatively large GNSS receiver due to the number of analog filters required, and the resulting GNSS receiver would not be a low power solution.

The disclosed system and method addresses the RF-digital signal interference issue with RF receivers. Heretofore, there has not been available an interference-mitigating RF system and method with the advantages and features of the disclosed invention.

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Certain terminology will be used in the following description for convenience in reference only and will not be limiting. The words “first”, “second”, etc., are used to indicated different elements that are the same or similar within a group and are not used to indicate priority or relative importance.

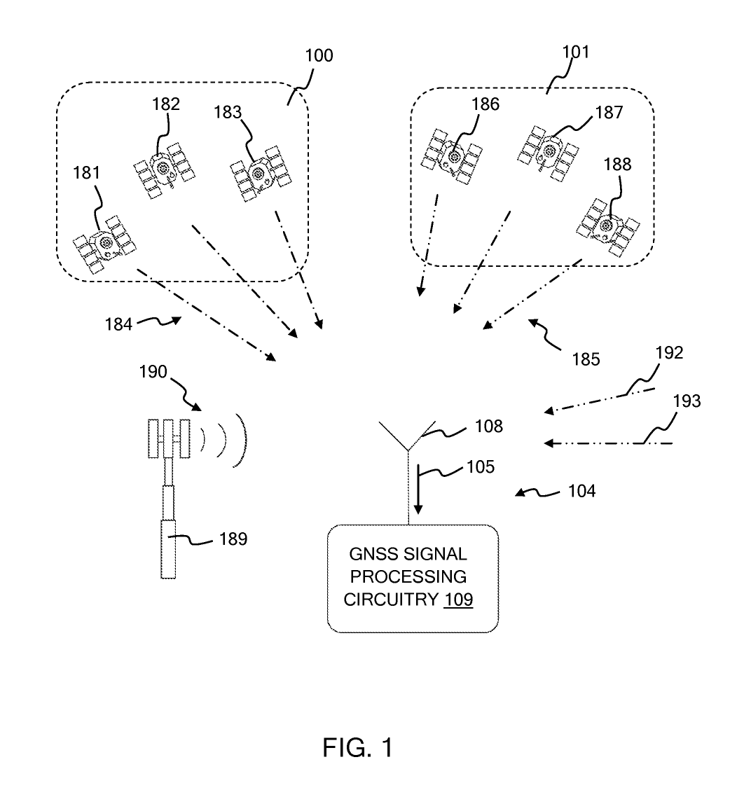

FIG. 1 shows a block diagram of a GNSS device 104 in an environment that includes both GNSS satellite signals and other RF signals of interest. GNSS device 104 is used for receiving and processing GNSS satellite signals and other RF signals of interest in order to compute the position, and in some situations the attitude, of GNSS device 104. GNSS device 104 mitigates the effects of interfering RF signals on the accuracy of GNSS computations performed by GNSS device 104.

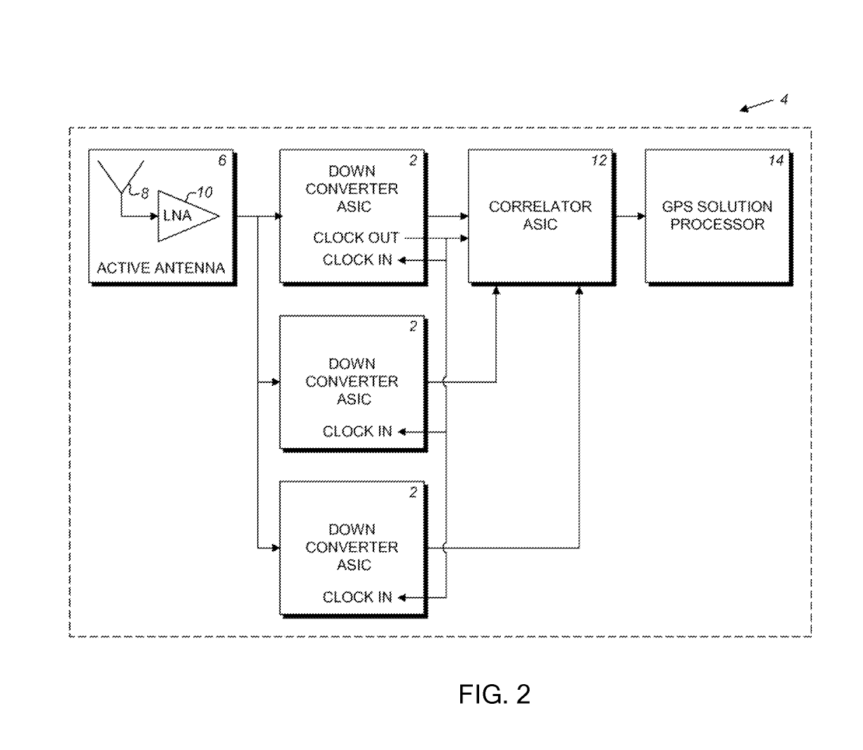

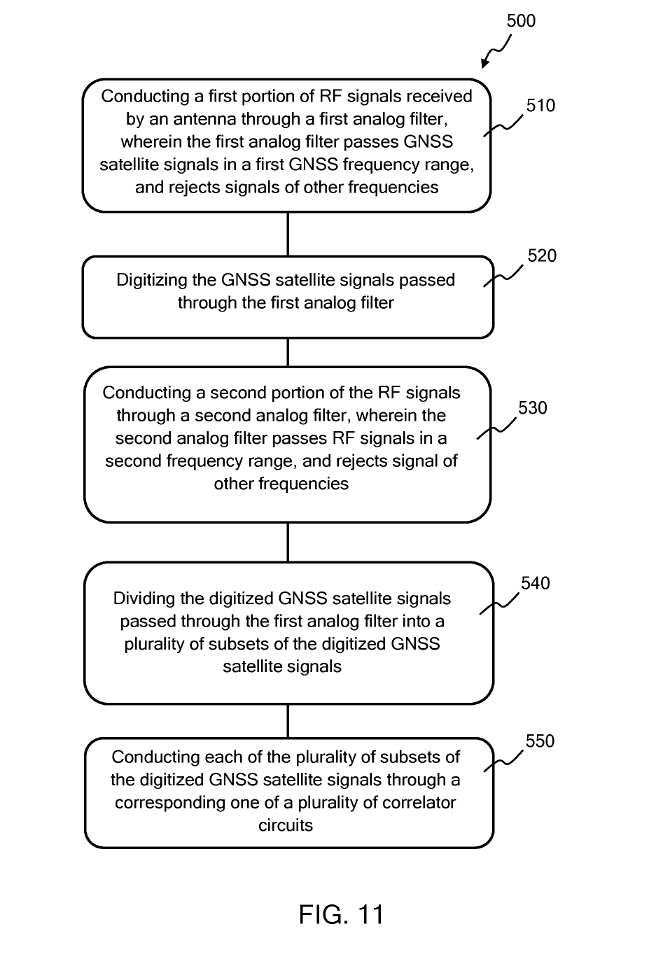

GNSS device 104 includes at least one antenna, which in this embodiment is an antenna 108. GNSS device 104 includes GNSS signal processing circuitry 109. Antenna 108 receives RF signals 105 and conducts RF signals 105 to GNSS signal processing circuitry 109. FIG. 2 through FIG. 10 show details of example embodiments of GNSS devices, including GNSS device 104, and other GNSS devices that can be used in place of GNSS device 104. FIG. 11 illustrates a method 500 of processing RF signals by a GNSS device. Method 500 can be performed by GNSS device 104 or any other GNSS device described herein.

Referring back to FIG. 1, antenna 108 receives RF signals 105 and conducts RF signals 105 to GNSS signal processing circuitry 109. RF signals 105 includes all signals received by antenna 108. RF signals 105 include both wanted and unwanted RF signals. In the embodiment shown in FIG. 1, antenna 108 receives a plurality of GNSS satellite signals 184 from a first GNSS constellation 100, and a plurality of GNSS satellite signals 185 from a second GNSS constellation 101. In this embodiment, antenna 108 also receives cellular signals 190 from cellular tower 189, wanted RF signals 192, and unwanted RF signals 193. Wanted RF signals 192 and unwanted RF signals 193 can originate from any of various RF signal sources. In some embodiments, wanted RF signals 192 include INMARSAT satellite signals with frequencies in the range of about 1525 MHz to about 1560 MHz. INMARSAT Company is a satellite phone company. In some embodiments, RF signals 192 include GNSS correction service signals with frequencies in the range of about 400-468 MHz. In some embodiments, RF signals 192 include GNSS correction service signals with frequencies in the range of about 900-928 MHz. In some embodiments, RF signals 192 includes other wanted RF signals that GNSS device 104 will use in its processing. RF signals 193 includes any unwanted RF signals that can interfere with the wanted RF signals 184, 185, and 192 received by GNSS device 104.

In some embodiments, it is desired that GNSS device 104 process only GNSS satellite signals, such as pluralities of GNSS satellite signals 100 and 101. In some embodiments, it is desired that GNSS device 104 process both GNSS satellite signals, such as pluralities of GNSS satellite signals 100 and 101, and cellular signals such as cellular telephone signals 190. In some embodiments, it is desired that GNSS device 104 process GNSS satellite signals, such as pluralities of GNSS satellite signals 100 and 101, cellular signals such as cellular telephone signals 190, and other RF signals such as RF signals 192. GNSS device 104 mitigates the interference effects of unwanted signals 193 on the operation and accuracy of GNSS device 104. The GNSS devices and methods disclosed herein provide hardware and processes for isolating those signals that are wanted from the spectrum of RF signals received, such as GNSS satellite signals 184 and 185, for example, and RF signals 190 and 192, and mitigating the interference from unwanted signals, such as unwanted signals 193, for example, as well as from adjacent sets of desired signals.

Antenna 108 of GNSS device 104 as shown in FIG. 1 receives GNSS satellite signals that originate from two different GNSS constellations. GNSS device 104 receives plurality of GNSS satellite signals 184 from GNSS constellation 100. In this embodiment GNSS constellation 100 is the GPS constellation of about 24 GNSS satellites, which includes GNSS satellites 181, 182, and 183, and may include additional satellites transmitting plurality of GNSS satellite signals 184. In some embodiments, GNSS constellation 100 is one of the other GNSS constellations in service around the world, now or in the future.

Antenna 108 of GNSS device 104 also receives plurality of GNSS satellite signals 185 from GNSS constellation 101. In this embodiment GNSS constellation 101 is one of the GNSS constellations in service around the world, which includes GNSS satellites 186, 187, and 188, and which transmit a plurality of GNSS satellite signals 185. In some embodiments, GNSS constellation 101 is the GPS constellation of about 24 satellites. In some embodiments, GNSS constellation 101 is a GNSS constellation put in service in the future.

In some embodiments, antenna 108 of GNSS device 104 receives GNSS satellite signals that originate from additional GNSS constellations. In some embodiments, GNSS device 104 receives GNSS satellite signals that originate from more than two GNSS constellations. In some embodiments, antenna 108 of GNSS device 104 receives GNSS satellite signals that originate from one GNSS constellation.

Pluralities of GNSS satellite signals 184 and 185 can include any GNSS satellite signals in any frequency range, including but not limited to these: L1 at 1575.42 MHz; L2 at 1227.60 MHz; L5 at 1176.45 MHz; B1 at 1561.01 MHz; B2 at 1207.14 MHz; B3 at 1268.52 MHz; G1 at 1602 MHz; G2 at 1246 MHz; E1 at 1575.42 MHz; E5 at 1191.795 MHz; E5A at 1176.45 MHz; E5B at 1207.14 MHz; and E6 at 1278.75 MHz.

FIG. 2 shows a block diagram of a GNSS device 4 that can be used in place of GNSS device 104 of FIG. 1. GNSS device 4 includes active antenna components 6, and analog signal conditioning circuits 2, which include down converter application specific integrated circuits (ASICs) 2 as shown. GNSS device 4 also includes a correlator ASIC 12, and a GPS solution processor 14. Analog signal conditioning circuits 2 execute multi-frequency down conversion of GNSS satellite signals as explained further below. GNSS device 4 can be employed in a wide range of useful applications, including navigation, guidance and machine control in various industries, such as, for example, precision farming, crop dusting, marine navigation, shipping, transportation, mining and manufacturing.

GNSS device 4 includes an antenna subsystem 6, having at least one antenna. In this embodiment, antenna subsystem 6 includes antenna 8 connected to a low noise amplifier (LNA) 10. The antenna subsystem 6 receives GNSS signals, amplifies them by means of LNA 10, and provides the amplified GNSS signals to one or more analog signal conditioning circuits 2. Analog signal conditioning circuits 2, which in this embodiment are ASICs 2, receive RF signals from antenna 8 and digitize at least a portion of the GNSS satellite signals from antenna 8, as explained herein. The output of each ASIC 2 is provided to a digital signal conditioning circuit 12, which in this embodiment is a correlator ASIC 12. Correlator ASIC 12 can include a pseudo-range engine, and provides input to a GNSS solution processor 14. The GNSS solution processor 14 can be connected to other components, such as graphical user interfaces (GUIs), autosteering devices, etc. GNSS solution processor 14 may also be connected to satellite augmentation systems (SASs) of various types, including free services such as the Wide Area Augmentation System (WAAS) and Omnistar (paid subscription service). These may be used to enhance the accuracy of the system 4 by providing GNSS corrections to GNSS device 4.

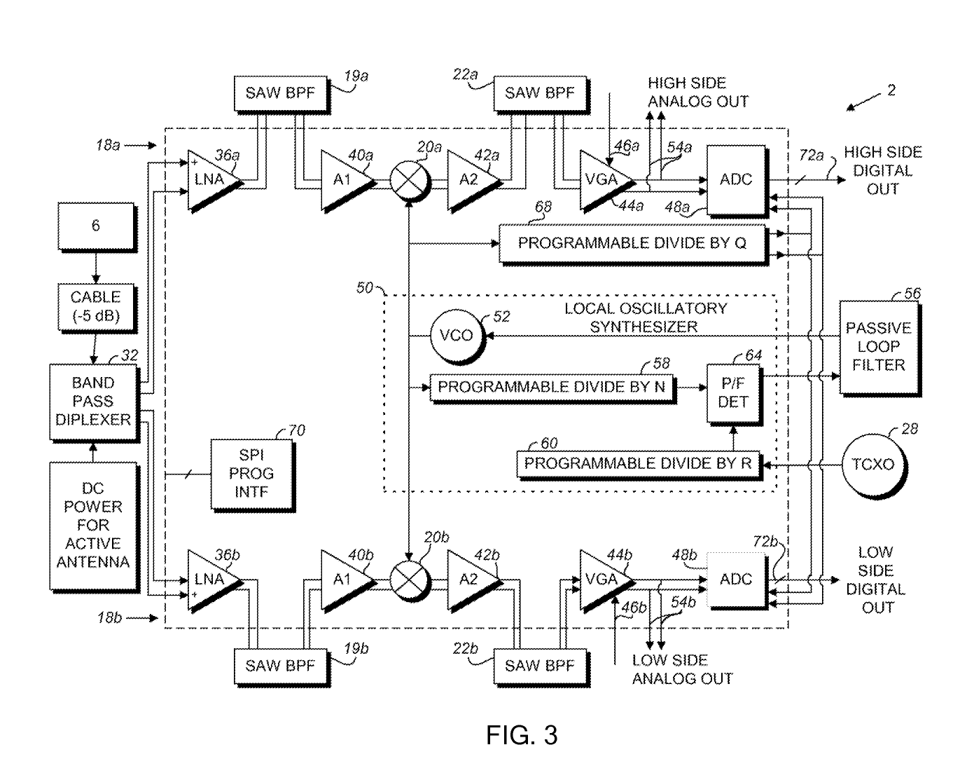

FIG. 3 shows in block diagram form an embodiment of analog signal conditioning ASIC 2, configured for operation as a down converter with input from an active antenna 6. Down conversion as used here designates changing the frequency of a signal to a lower frequency, and a down converter as used herein is a circuit or device that performs the down conversion of a signal. In the embodiment of FIG. 3, active antenna 6 has a gain of, for example, +30 dB, and is connected to a band pass diplexer 32 configured to provide GNSS signals for further processing by ASIC 2 via signal paths 18a,b. Signal paths 18a,b include LNAs 36a,b, respectively, each of which is connected to the diplexer 32 and to first stage surface acoustic wave (SAW) band pass filters 19a,b, respectively. In the embodiment of FIG. 3, SAW band pass filters 19a,b are located external to the ASIC 2. RF amplifiers 40a,b (A1) receive signals from the SAW band pass filters 19a,b respectively. RF amplifiers 40a,b amplify the received signals, and provide the amplified signals to mixers 20a,b, respectively. Mixers 20a,b are connected to intermediate frequency (IF) amplifiers 42a,b (A2), which amplify the signals and provide them to second stage band pass filters 22a,b, respectively. Second stage band pass filters 22a,b receive signals from the IF amplifiers 42a,b and provide signal inputs to variable gain amplifiers (VGAs) 44a,b, which are connected to and controlled by automatic gain control (AGC) signals 46a,b. The variable gain amplifiers 44a,b provide signal inputs to analog-to-digital converters (ADCs) 48a,b, which respectively provide digital outputs 72a,b from the high and low sides of ASIC 2, corresponding to high and low signal paths 18a,b. Variable gain amplifiers 44a,b also provide analog outputs 54a,b from high and low sides of ASIC 2 corresponding to high and low signal paths 18a,b.

A common local oscillator/synthesizer (LO/Synth) 50 is coupled to both signal paths 18a,b. LO/Synth 50 in this embodiment includes a voltage controlled oscillator (VCO) 52 connected to mixers 20a,b and to an external passive loop filter 56. LO/Synth 50 also includes a Programmable Divide by N Counter (1/N) 58 connected to VCO 52 and a phase/frequency detector 64. LO/Synth 50 also includes a Programmable Divide by R (1/R) 60 which is connected to phase/frequency detector (P/F Det) 64. Programmable Divide by R 60 receives signals from an external temperature controlled crystal oscillator (TCXO) 28. The analog-to-digital clock divider Programmable Divide by Q (1/Q) 68 is connected to mixers 20a,b and to analog-to-digital converters (ADCs) 48a,b. ADC 48a,b perform a second down conversion of the GNSS signals, in response to the input from Programmable Divide by Q 68. When the input from Programmable Divide by Q 68 undersamples the GNSS signal input to ADC 48a,b, multiple digital outputs from ADC 48a,b are provided by ADC 48a,b. Thus by choosing a digital output from ADC 48a,b with a frequency less than the GNSS satellite signal input frequency, an optional second down conversion of the GNSS satellite signal is available at the outputs of ADC 48a,b. The value of Q can be chosen to optimize the frequency of the down-converted GNSS satellite signal, and keep the down-converted signal free from interference with other sum and difference frequencies output by ADC 48a,b. Thus in analog signal conditioning ASIC 2, the GNSS satellite signal undergoes two frequency down conversions, a first down conversion from mixer 20a,b where the GNSS satellite signal output from mixer 20a,b is a frequency lower than the GNSS satellite signal input to mixer 20a,b, and a second down conversion from ADC 48a,b, where the chosen digitized GNSS satellite signal output from ADC 48a,b is at a frequency lower than the GNSS satellite signal input to ADC 48a,b.

A serial peripheral programming interface (SPI) 70 (FIG. 3) is provided for interfacing with external devices whereby the operation of down converter ASIC 2 can be externally controlled by preprogramming such variables as “divide by” values, on/off switching and other components' controls. In the embodiment of FIG. 3, band pass filters 19a,b and 22a,b, are physically mounted exterior to the circuit board that includes the remaining components of down converter ASIC 2. This enables a relatively “universal” down converter ASIC 2 to be utilized in various GNSS receiver devices, accommodating a wide range of current and future GNSS satellite signals. Such GNSS receiver devices 4 can include multiple band pass filters and other components external to the down converter ASIC 2, whereby the system can be switched among various filter combinations for multi-frequency operation. Such switching can occur automatically, e.g., via software operation selecting the best available satellite constellations, or manually by an operator based on current satellite availability. Respective high and low side digital outputs 72a,b provide digital data that can be processed by digital processing circuitry. In the embodiment of FIG. 3, high and low side digital outputs 72a,b are output “words,” comprising 4 bit each in the form of digital signals output from the ADCs 48a,b. Respective high and low side analog outputs 54a,b, provide analog outputs which can be connected to external analog to digital converters that provide higher bit resolution for example, than the on-chip analog-to-digital-converters 48a,b. In some embodiments, ADCS 48a,b are variable output bit ADCs, where the number of output bits is operator controlled.

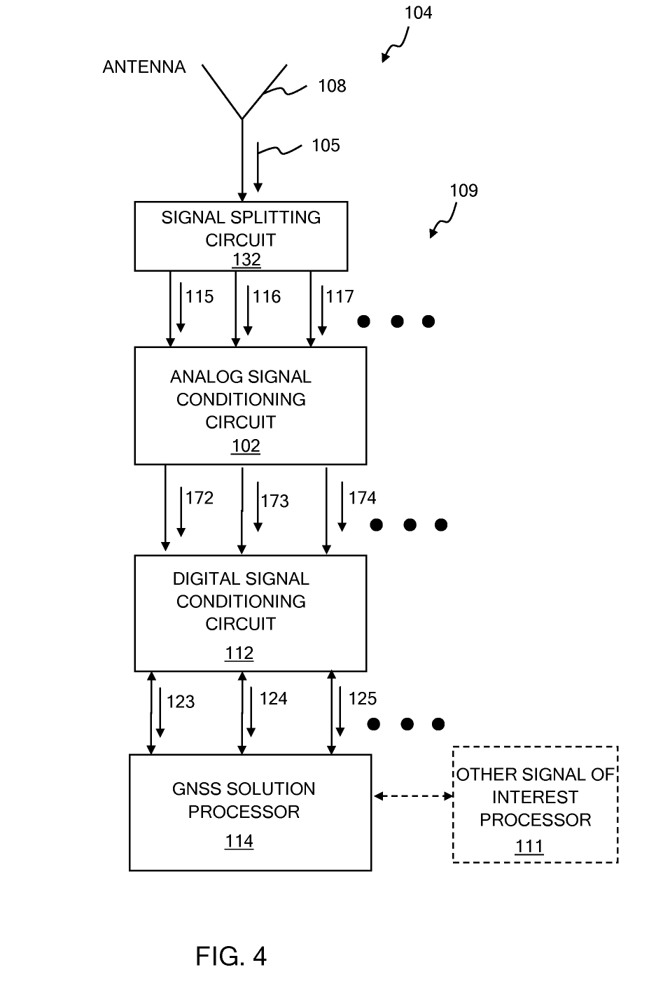

FIG. 4 shows a simplified block diagram of an embodiment of GNSS device 104 of FIG. 1 for capturing and processing GNSS satellite signals and other signals of interest. GNSS device 104 includes at least one antenna, which in this embodiment is an antenna 108. In some embodiments, GNSS device 104 includes more than one antenna. Antenna 108 captures RF signals 105 and conducts RF signals 105 to a signal splitting circuit 132. In some embodiments, signal splitting circuit 132 is a low-noise amplifier (LNA) circuit. GNSS device 104 also includes an analog signal conditioning circuit 102, a digital signal conditioning circuit 112, and a GNSS solution processor 114. In some embodiments, GNSS device 104 includes an other signal of interest processor 111, indicated as optional by showing other signal of interest processor 111 in dotted lines.

Antenna 108 receives RF signals 105, which in this embodiment includes pluralities of GNSS satellite signals 184 and 185, RF signals 190, which in this embodiment are cellular telephone signals 190, and RF signals 192. RF signals 192 are other types and frequencies of RF signals of interest. RF signals 192 can be any kind, type, or frequency of signals of interest to GNSS device 104. Antenna 108 also receives unwanted RF signals 193. GNSS device 104 processes RF signals 105, while mitigating the effects of unwanted signals 193 on the operation of GNSS device 104 as explained below.

Signal splitting circuit 132 divides RF signals 105 into two or more superbands of signal frequencies, often using bandpass filters, as explained for signal splitting circuits 232 and 432 below. Signal splitting circuit 123 divides RF signals 105 into superbands of RF signals according to which frequency bands are desired to be collected and processed by GNSS device 104. In the embodiment shown in FIG. 4, signal splitting circuit 132 divides RF signals 105 into three or more superbands of signals, but this is not meant to be limiting. In some embodiments, signal splitting circuit 132 divides RF signals 105 into two bands of signals. In the embodiment shown in FIG. 4, signal splitting circuit 132 receives RF signals 105 from antenna 108, and outputs RF signals 115 in a first frequency range, RF signals 116 in a second frequency range, and RF signals 117 in a third frequency range in response.

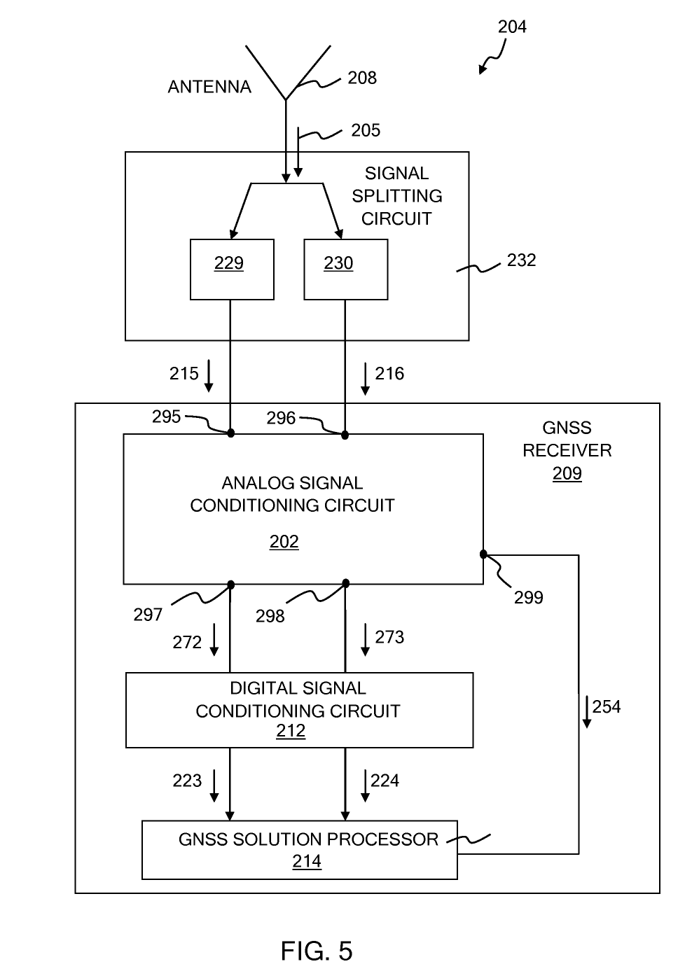

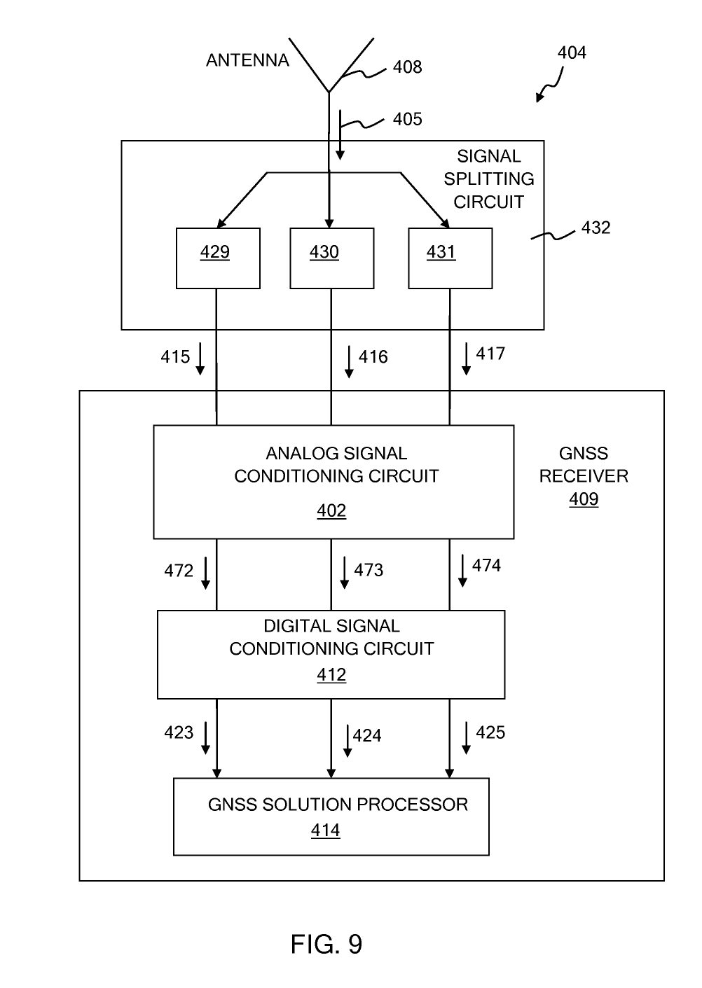

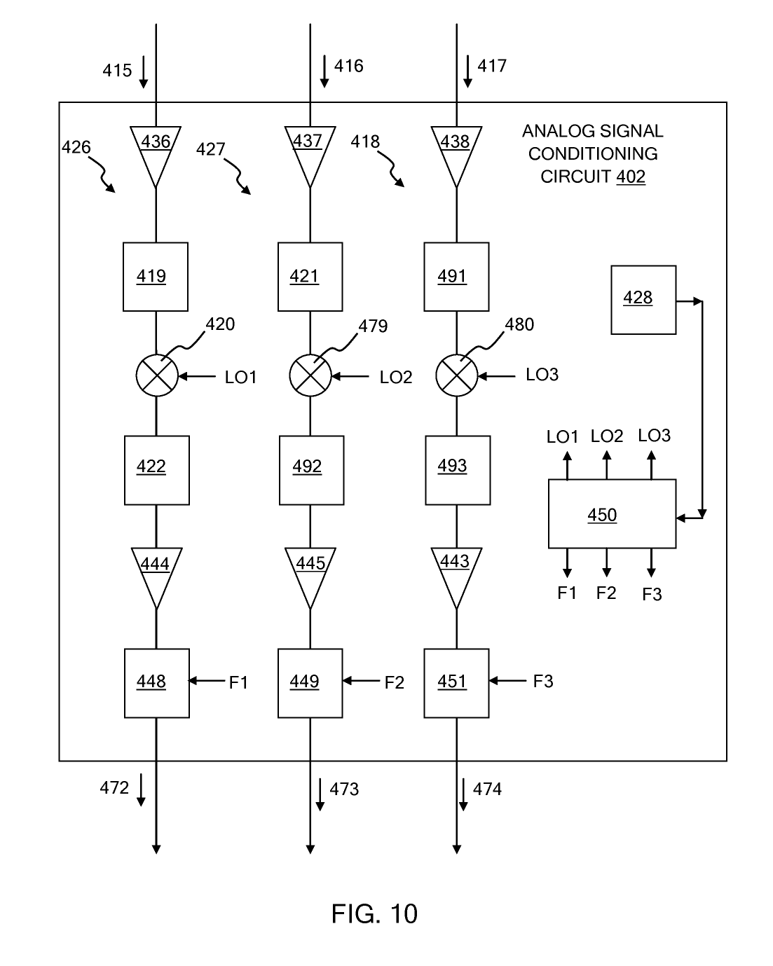

Analog signal conditioning circuit 102 is electrically coupled to signal splitting circuit 132, and receives RF signals 115, 116, and 117 from signal splitting circuit 132. RF signals 115, 116, and 117 can be GNSS satellite signals or other RF signals of interest. Analog signal conditioning circuit 102 performs analog processing on RF signals 115, 116, and 117. This analog processing can include amplification, filtering, frequency conversion, sampling, and other signal processing. Analog signal conditioning circuit 102 can be replaced with ASIC 2 of FIG. 2 and FIG. 3, analog signal conditioning circuit 202 of FIG. 5 through FIG. 7, or analog signal conditioning circuit 402 of FIG. 9 and FIG. 10. Analog signal conditioning circuit 102 digitizes RF signals 115, 116, and 117. Digitized RF signals 115, 116, and 117 are labeled RF signals 172, 173, and 174 in this embodiment. Analog signal conditioning circuit 102 digitizes RF signals 115, 116, and 117 and conducts digitized RF signals 172, 173, and 174 to digital signal conditioning circuit 112 in response. In some embodiments, analog signal conditioning circuit 104 digitizes only a portion of RF signals 115, 116, and 117 (see, for example, the discussion of GNSS device 204 of FIG. 5). Analog signal conditioning circuit 102 can include many types of analog signal filtering or processing elements, and can perform many different types of analog filtering and processing operations on RF signals 115, 116, and 117.

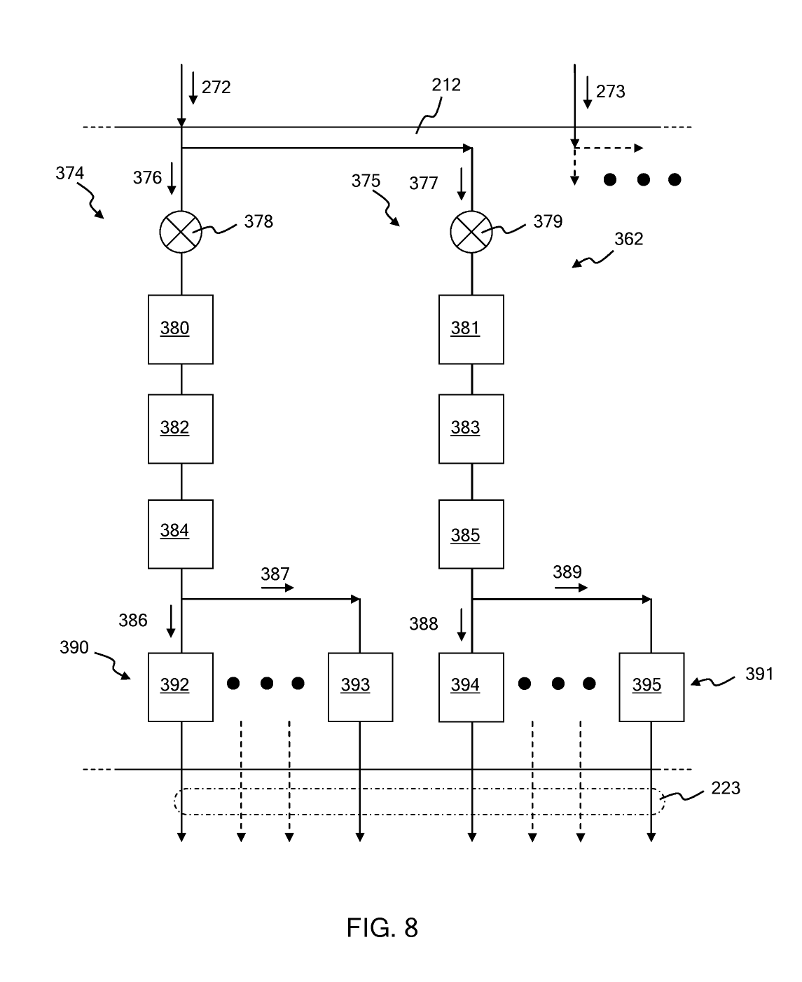

Digital signal conditioning circuit 112 is electrically coupled to analog signal conditioning circuit 102, and receives RF signals 172, 173, and 174 from analog signal conditioning circuit 102. Digital signal conditioning circuit 112 digitally processes RF signals 172, 173, and 174, and outputs digitally processed RF signals 123, 124, and 125 in response. In some embodiments, digital signal conditioning circuit 112 conducts RF signals 172, 173, 174 through one or more correlator circuits, and provides correlator output signals 123, 124, and 125 to GNSS solution processor 114. In some embodiments, digital signal conditioning circuit 112 is replaced with digital signal conditioning circuit 212 of FIG. 5 and FIG. 8. Digital signal conditioning circuit 112 can include any type of digital signal filtering or processing elements, and can perform many different types of digital filtering and processing operations on RF signals 172, 173, and 174.

Analog signal conditioning circuit 102 and digital signal conditioning circuit 112 perform signal filtering, amplification, frequency shifting, digitization, and channelization in order to capture and clean the GNSS signals of interest and/or other signals of interest, and deliver them to GNSS solution processor 114. Analog signal conditioning circuit 102 and digital signal conditioning circuit 112 divide the signal filtering and processing of RF signals 115, 116, and 117 among the analog domain and the digital domain in order to minimize power consumption and physical size of GNSS device 104, and to maximize the noise filtering capabilities of GNSS device 104.

GNSS solution processor 114 is electrically coupled to digital signal conditioning circuit 112 and receives signals 123, 124, and 125 from digital signal conditioning circuit 112. GNSS solution processor 114 performs GNSS computations on signals 123, 124, and 125 to compute GNSS location, GNSS attitude, and other desired GNSS outputs. In some embodiments, GNSS solution processor 114 is electrically coupled to, and receives signals from, other signal of interest processor 111. Other signals of interest can provide correction data, controls, or other types of information, command, and controls to GNSS solution processor 114. In some embodiments, for example, but not by way of limitation, other signal of interest processor 111 is a cellular telephone modem. In some embodiments, other signal of interest processor 111 receives cellular telephone signals from antenna 108 and provides data and/or signals from the cellular telephone signals to GNSS solution processor 114. Other signal of interest processor 111 can receive and process many different types of signals for use by GNSS solution processor 114.

It is to be understood that GNSS device 104 can include many other types of circuitry for processing, filtering, and performing signal processing operations on RF signals 115, 116, and 117.

FIG. 5 shows a simplified block diagram of an embodiment of a GNSS device 204. GNSS device 204 captures and processes GNSS satellite signals from one or more GNSS satellite constellations, as well as other RF signals of interest, as shown with GNSS device 104 in FIG. 1. In this embodiment, GNSS device 204 is used in place of GNSS device 104 in FIG. 1.

GNSS device 204 receives RF signals 205 with at least one antenna, which in the embodiment shown in FIG. 5 is antenna 208. RF signals 205 can include any or all of the RF signals shown in FIG. 1, as well as other RF signals of any type and frequency. For example, GNSS device 204 in this embodiment receives plurality of GNSS satellite signals 184 from GNSS constellation 100, and plurality of GNSS satellite signals 185 from GNSS constellation 101, as shown in FIG. 1. In some embodiments, GNSS device 204 receives pluralities of GNSS satellite signals from more than two GNSS constellations. GNSS device 204 also receives cellular telephone signals 190, wanted RF signals 192 and unwanted RF signals 193, as shown for GNSS device 104 in FIG. 1.

GNSS device 204 includes a signal splitting circuit 232 and a GNSS receiver 209. GNSS receiver 209 is electrically coupled to signal splitting circuit 232, and receives RF signals 215 and 216 from antenna 205 through signal splitting circuit 232. GNSS receiver 209 includes an analog signal conditioning circuit 202, a digital signal conditioning circuit 212, and a GNSS solution processor 214. Analog signal conditioning circuit 202 and digital signal conditioning circuit 212 perform signal filtering, frequency shifting, digitization, and channelization in order to capture and clean the GNSS signals of interest and/or other RF signals of interest, and deliver them to GNSS solution processor 214. GNSS solution processor 214 performs GNSS computations such as location determination and attitude determination, as well as other GNSS computations.

Antenna 208 captures RF signals 205 and conducts RF signals 205 to signal splitting circuit 232. In some embodiments, signal splitting circuit 232 is a LNA circuit. Signal splitting circuit 232 includes two bandpass filters, a bandpass filter 229 and a bandpass filter 230. However, in some embodiments, signal splitting circuit 232 includes more than two bandpass filters. Each bandpass filter 229 and 230 of signal splitting circuit 232 passes a band of RF signals, and blocks signals outside its passband. Thus, signals outside the passbands of bandpass filters 229 and 230 are blocked from reaching GNSS receiver 209. Signal splitting circuit 232 includes a plurality of bandpass filters, one bandpass filter to capture each frequency band of interest, either a GNSS satellite signal frequency band, or other RF signal of interest frequency band. GNSS device includes enough bandpass filters in signal splitting circuit 232 to subdivide the frequencies of interest and the GNSS satellite signals received by antenna 208 into frequency bands, so that all signals of interest and GNSS satellite signals are passed through a bandpass filter, and a majority of unwanted signals 193, signals not of interest, are blocked from passing through signal splitting circuit 232.

Signal splitting circuit 232 receives RF signals 205 from antenna 208, and outputs RF signals 215 and 216 in response. For example, bandpass filter 229 receives RF signals 205 from antenna 208, passes RF signals 215 in a first frequency range, and rejects signals of other frequencies. RF signals 215 in the first frequency range are passed by bandpass filter 229 and conducted to analog signal conditioning circuit 202 of GNSS receiver 209. In this embodiment, RF signals 215 are GNSS satellite signals 215 in the first frequency range, but this is not meant to be limiting. RF signals 215 can be cellular telephone signals, INMARSAT signals, GNSS correction service signals, or other RF signals of interest. In the embodiment of GNSS device shown in FIG. 5, the first frequency range is from about 1553 megahertz (MHz) to about 1609 MHz, but this is not meant to be limiting. In some embodiments, the first frequency range is from about 1217 MHz to about 1289 MHz. In some embodiments, the first frequency range is from about 1165 MHz to about 1217 MHz. In some embodiments, the first frequency range is from about 1525 MHz to about 1560 MHz. In some embodiments, the first frequency range is from about 400 MHz to about 468 MHz. In some embodiments, the first frequency range is from about 900 MHz to about 928 MHz. In some embodiments, the first frequency range is a different frequency range.

Bandpass filter 230 receives RF signals 205 from antenna 208, passes RF signals 216 in a second frequency range, and rejects signals of other frequencies. RF signals 216 in the second frequency range are passed by bandpass filter 230 and conducted to analog signal conditioning circuit 202 of GNSS receiver 209. RF signals 216 can be GNSS satellite signals, cellular telephone signals, INMARSAT signals, GNSS correction service signals, or other RF signals of interest. RF signals 216 can be any of the RF signal frequency ranges discussed above for RF signals 215, or other signal frequency ranges.

Analog signal conditioning circuit 202 receives RF signals 215 and 216 from signal splitting circuit 232, and outputs digitized RF signals 272, digitized RF signals 273 and/or analog RF signals 254 in response, as explained herein.

In this embodiment, RF signals 215 are GNSS satellite signals, and RF signals 216 are either GNSS satellite signals or other RF signals such as cellular telephone signals, GNSS correction service signals, satellite telephone signals, or other types of RF signals. In some embodiments, both RF signals 215 and RF signals 216 are GNSS satellite signals. In some embodiments, both RF signals 215 and RF signals 216 are other RF signals. Analog signal conditioning circuit 202 receives and processes RF signals 215 and 216. The processing that analog signal conditioning circuit 202 performs on RF signals 215 and 216 includes digitizing at least a portion of RF signals 215 and 216, as explained further below. Digitized GNSS satellite signals 215 are labeled 272 in FIG. 5, and are conducted to digital signal conditioning circuit 212 as shown. Digitized RF signals 216 are labeled 273 in FIG. 5, and are conducted to digital signal conditioning circuit 212. In some applications, at least a portion of RF signals 216 remain analog signals. The portion of RF signals 216 that remain analog are labelled as signals 254 in FIG. 5, and are conducted to GNSS solution processor 214.

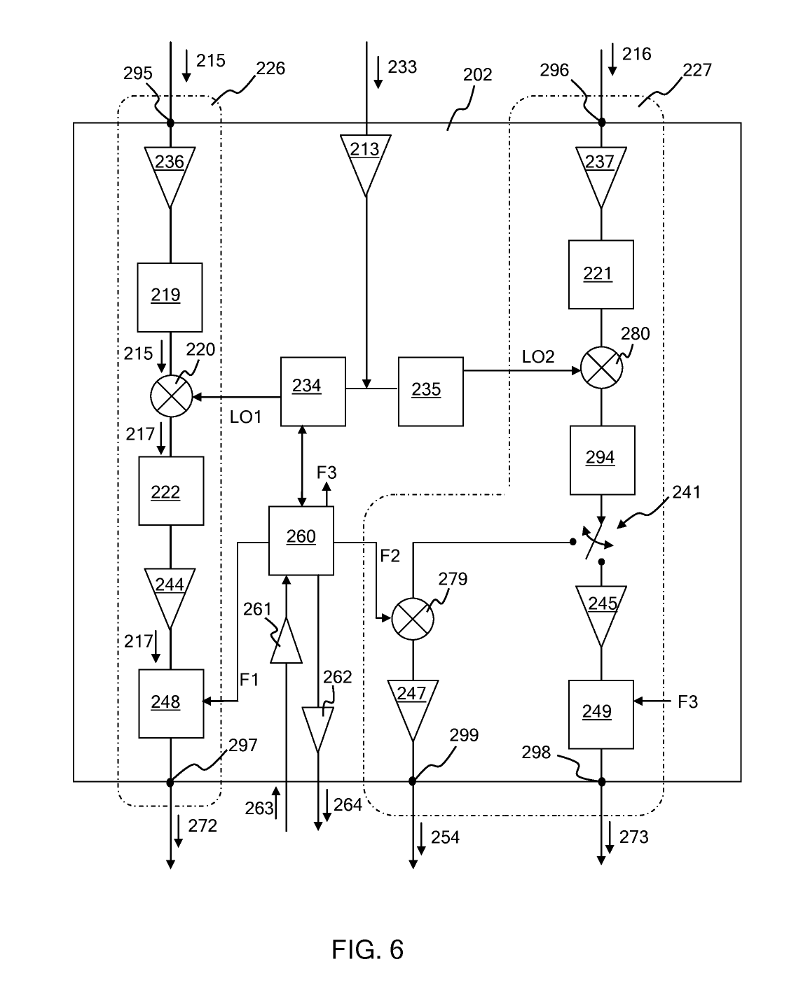

Referring concurrently to FIG. 5 and FIG. 6, FIG. 6 shows one example embodiment of analog signal conditioning circuit 202 of FIG. 5. Analog signal conditioning circuit 202 includes two signal filtering/processing channels, also called signal transmission paths, but this is not meant to be limiting. In some embodiments, analog signal conditioning circuit 202 includes more than two signal transmission paths. In this embodiment analog signal conditioning circuit 202 includes a signal transmission path 226 and a signal transmission path 227. Analog signal conditioning circuit 202 is electrically coupled to signal splitting circuit 232, and receives GNSS satellite signals 215 and RF signals 216 from signal splitting circuit 232. Analog signal conditioning circuit 202 digitizes at least a portion of signals 215 and 216, but not necessarily all of signals 215 and 216. GNSS satellite signals 215 are digitized by an ADC circuit 248 before they are conducted to digital signal conditioning circuit 212. In this embodiment, analog signal conditioning circuit 202 includes a switch 241, which delivers RF signals 216 to either an analog-to-digital converter (ADC) circuit 249, or to a frequency mixer 279 and an amplifier 247, as shown in FIG. 6. When RF signals 216 are conducted through frequency mixer 279 instead of ADC circuit 249, RF signals 216 are not digitized, but are instead conducted to GNSS solution processor 214 as analog signals 254 as shown in FIG. 5 and FIG. 6.

Analog signal conditioning circuit 202 receives GNSS satellite signals 215 at an input node 295. Signal transmission path 226 of analog signal conditioning circuit 202 conducts GNSS satellite signals 215 from input node 295 to output node 297 through the electrical components of signal transmission path 226, which includes ADC circuit 248. Digitized GNSS satellite signals 215 are output from ADC circuit 248, and are labeled 272 in FIG. 5 and FIG. 6.

Signal transmission path 226 includes variable gain amplifiers 236 and 244, analog bandpass filters 219 and 222, a frequency mixer 220, and analog-to-digital converter circuit 248. Variable gain amplifier (VGA) 236 is electrically coupled to input node 295, and receives GNSS satellite signals 215 in the first frequency range from antenna 208 and signal splitting circuit 232, through first input node 295, and outputs amplified GNSS satellite signals 215 in the first frequency range in response. Bandpass filter 219 is electrically coupled to input node 295 through variable gain amplifier 236, and receives GNSS satellite signals 215 from variable gain amplifier 236. Bandpass filter 219 filters amplified GNSS satellite signals 215 in the first frequency range, passing GNSS satellite signals 215 in the first frequency range, and blocking other frequencies. In some embodiments, filter 219 is a SAW bandpass filter. In some embodiments, filter 219 is mounted remote from the circuit board that includes most of the circuitry of analog signal conditioning circuit 202. This facilitates replacing filter 219 for the purpose of changing the pass band characteristics of filter 219, for example.

Frequency mixer 220 is electrically coupled to bandpass filter 219 and receives filtered and amplified GNSS satellite signals 215 in the first frequency from bandpass filter 219, and outputs analog GNSS satellite signals 217 in a third frequency range in response. Frequency mixer 220 shifts the frequency of filtered GNSS satellite signals 215. GNSS satellite signals 215 that are frequency-shifted are labeled GNSS satellite signals 217 in FIG. 6. In this embodiment, frequency mixer 220 downconverts the frequency of GNSS satellite signals 215, in other words, frequency mixer shifts the frequency of GNSS satellite signals 215 to a lower frequency. The third frequency range is a frequency range lower than the first frequency range, and GNSS satellite signals 217 have a lower frequency than GNSS satellite signals 215.

Bandpass filter 222 is electrically coupled to frequency mixer 220 and receives GNSS satellite signals 217 in the third frequency range from frequency mixer 220. Bandpass filter 222 performs further analog filtering on GNSS satellite signals 217, passing frequency-shifted GNSS satellite signals 217 in the third frequency range, and blocking signals of other frequencies. In some embodiments, filter 222 is a SAW bandpass filter. In some embodiments, filter 222 is mounted remote from the circuit board that includes most of the circuitry of analog signal conditioning circuit 202, as with bandpass filter 219. This facilitates replacing filter 222 for the purpose of changing the pass band characteristics of filter 222, for example.

Variable gain amplifier (VGA) 244 is electrically coupled to bandpass filter 222, and receives GNSS satellite signals 217 from bandpass filter 222. ADC 248 is electrically coupled to VGA 244 and receives GNSS satellite signals 217 from VGA 244. ADC circuit 248 digitizes GNSS satellite signals 217, and frequency-shifts GNSS satellite signal 217, as described earlier with regard to ADC 48a,b of FIG. 3. ADC circuit 248 receives analog GNSS satellite signals 217 in the third frequency range, and outputs digital GNSS satellite signals 272 in a fourth frequency range in response. In this embodiment ADC downconverts GNSS satellite signals 217 such that the fourth frequency range is a lower frequency range than the third frequency range. Thus, digital GNSS satellite signals 272 of the fourth frequency range have been down-converted twice. Digitized and twice frequency-shifted (once by mixer 220 and once by ADC 248) GNSS satellite signals 215, labeled GNSS satellite signals 272, exit analog signal conditioning circuit 202 at output node 297. GNSS satellite signals 272 are conducted from output node 297 to digital signal conditioning circuit 212.

Analog signal conditioning circuit 202 conducts RF signals 216 through signal transmission path 227. Signal transmission path 227 includes switch 241, which conducts RF signals 216 from an input node 296 to either an output node 298 or an output node 299, depending on the state, or position, of switch 241. Switch 241 is used to bypass ADC circuit 249 when it is desired that RF signals 216 remain as analog signals. It may be desired to have RF signals 216 remain in analog form when RF signals 216 are not GNSS satellite signals, for example, but this is just one of many reasons why it may be desired that RF signals 216 remain in analog form.

Signal input node 296 is electrically coupled to signal splitting circuit 232, and receives RF signals 216 from antenna 208 through signal splitting circuit 232. Signal output node 298 is electrically coupled to signal input node 296 through switch 241. Signal output node 299 is also electrically coupled to signal input node 296 through switch 241. Signal transmission path 227 conducts RF signals 216 from signal input node 296 through ADC circuit 249 to signal output node 298 when switch 241 is in a first position. Signal output node 298 is electrically coupled to digital signal conditioning circuit 212. Digitized RF signals 216, labeled 273 in the figures, are conducted from signal output node 298 to digital signal conditioning circuit 212 as shown in FIG. 6.

Signal transmission path 227, alternatively, conducts RF signals 216 from signal input node 296 to signal output node 299 when switch 241 is in a second position. Signal transmission path 227 conducts RF signals 216 from signal input node 296 to signal output node 299 through a frequency mixer 279 when switch 241 is in the second position. Signal output node 299 is electrically coupled to GNSS solution processor 214. Frequency-shifted analog RF signals 216, labeled signals 254 in the figures, are conducted from signal output node 299 to GNSS solution processor 214 as shown in FIG. 6. Switch 241 is controlled by the user, or by computer or electronic control according to decisions programmed by the user of GNSS device 204.

Signal transmission path 227 includes variable gain amplifiers 237, 245, and 247, analog bandpass filters 221 and 294, frequency mixers 280 and 279, switch 241, and analog-to-digital converter circuit 249. Variable gain amplifier (VGA) 237 is electrically coupled to input node 296, and receives analog RF signals 216 in the second frequency range from signal splitting circuit 232 through signal input node 296. Bandpass filter 221 is electrically coupled to input node 296 through variable gain amplifier 237, and receives RF signals 216 from signal splitting circuit 232 through signal input node 296 and variable gain amplifier 237. Bandpass filter 221 further filters RF signals 216, passing RF signals 216 in the second frequency range and blocking other frequencies. Frequency mixer 280 is electrically coupled to bandpass filter 221 and receives RF signals 216 from bandpass filter 221. Frequency mixer 280 shifts the frequency of RF signals 216. In this embodiment, frequency mixer 280 downconverts the frequency of RF signals 216 from the second frequency range to a fifth frequency range.

Bandpass filter 294 is electrically coupled to frequency shifter 280 and receives frequency-shifted RF signals 216 from frequency shifter 280. Bandpass filter 294 performs further analog filtering on RF signals 216, passing frequency-shifted RF signals 216 and blocking other signals. In some embodiments, filters 221 and/or 294 are SAW bandpass filters. In some embodiments, filters 221 and/or 294 are mounted remote from the circuit board that includes most of the circuitry of analog signal conditioning circuit 202, similar to filters 219 and 222. This facilitates replacing filters 221 and/or 294 for the purpose of changing the pass band characteristics of filters 221 and/or 294, for example.

Switch 241 controls whether frequency-shifted RF signals 216 are conducted to signal output node 298 through VGA 245 and ADC circuit 249, or to signal output node 299 through frequency mixer 279 and VGA 247. When switch 241 is in a first position, switch 241 electrically couples bandpass filter 294 and VGA 245, and electrically isolates frequency mixer 279 from bandpass filter 294. When switch 241 is in the first position, frequency-shifted RF signals 216 are conducted from bandpass filter 294 through switch 241, through VGA 245, through ADC circuit 249, to signal output node 298. In this embodiment ADC 249 performs a further frequency downconversion, but this is not meant to be limiting. The digitized and twice frequency-shifted RF signals 216 are labeled RF signals 273 in FIG. 5 and FIG. 6, and are conducted from signal output node 298 to digital signal conditioning circuit 212.

When switch 241 is in a second position, switch 596 electrically couples bandpass filter 294 and frequency mixer 279, and electrically isolates VGA 245 from bandpass filter 294. When switch 241 is in the second position, frequency-shifted RF signals 216 are conducted from bandpass filter 294 through switch 241, through frequency mixer 279 and VGA 247 to signal output node 299. Frequency mixer 279 shifts the frequency of analog RF signals 216 a second time. The twice frequency-shifted analog RF signals 216 are labeled RF signals 254 in FIG. 5 and FIG. 6, and are conducted from signal output node 299 to GNSS solution processor 214. Switch 241, frequency mixer 279, and VGA 247 are used, for example but not by way of limitation, when RF signals 216 are not GNSS signals, but instead are remote control, correction, or other informational signals such as INMARSAT signals, cellular or satellite cellular telephone signals, or correction service signals. In these situations, it is not desired to digitize RF signals 216, but instead to filter and frequency shift RF signals 216 and deliver them to GNSS solution processor 214 as analog RF signals 254.

Thus switch 241 is used in signal transmission path 227 to direct RF signals 216 through different processing paths based on the type of processing desired for RF signals 216. When it is desired to digitize RF signals 216, switch 241 can be put in the first position, where signal transmission path 227 conducts RF signals 216 through a signal filtering and processing channel similar to that contained in signal transmission path 226, with RF signals 216 being digitized, downconverted in frequency by ADC 249, and conducted to digital signal conditioning circuit 212. When it is desired to not digitize RF signals 216, switch 241 can be put in the second position, where signal 216 are not digitized, but instead shifted in frequency by mixer 279 and conducted to GNSS solution processor 214 as analog RF signals 254.

RF signal transmission paths 226 and 227 can include many other elements. In some embodiments, signal transmission path 226 includes an anti-aliasing filter between AGC 244 and ADC circuit 248. An anti-aliasing filter removes frequencies that can cause interference modulations in the desired signal. In some embodiments, signal transmission path 227 includes an anti-aliasing filter between AGC 245 and ADC circuit 249.

Analog signal conditioning circuit 202 also includes amplifier 213, 261, and 262, oscillators 234 and 235, and ADC clock 260. Oscillators 234 and 235 receive a reference frequency input signal 233 through amplifier 213. Oscillator 234 outputs a frequency signal LO1 to frequency mixer 220. Oscillator 235 outputs a frequency signal LO2 to frequency mixer 280. ADC clock 260 receives ADC clock input signal 263 through VGA 261. ADC clock 260 provides ADC clock output signal 264 through VGA 262, as well as clock frequency signal F1 to ADC 248, clock frequency signal F2 to mixer 279, and clock frequency signal F3 to ADC 249. The schematic elements, and interconnects shown for analog signal conditioning circuit 202 are exemplary only, and other interconnects and elements are possible.

It is desired that the total gain through signal transmission paths 226 and 227 is variable over a wide range. In some embodiments, VGA 244 is implemented as two VGAs in series to increase the gain range and gain level flexibility of signal transmission path 226. In some embodiments, VGA 245 is implemented as two VGAs in series to increase the gain range and gain level flexibility of signal transmission path 227. In some embodiments, VGA 247 is implemented as two VGAs in series to increase the gain range and gain level flexibility of signal transmission path 227.

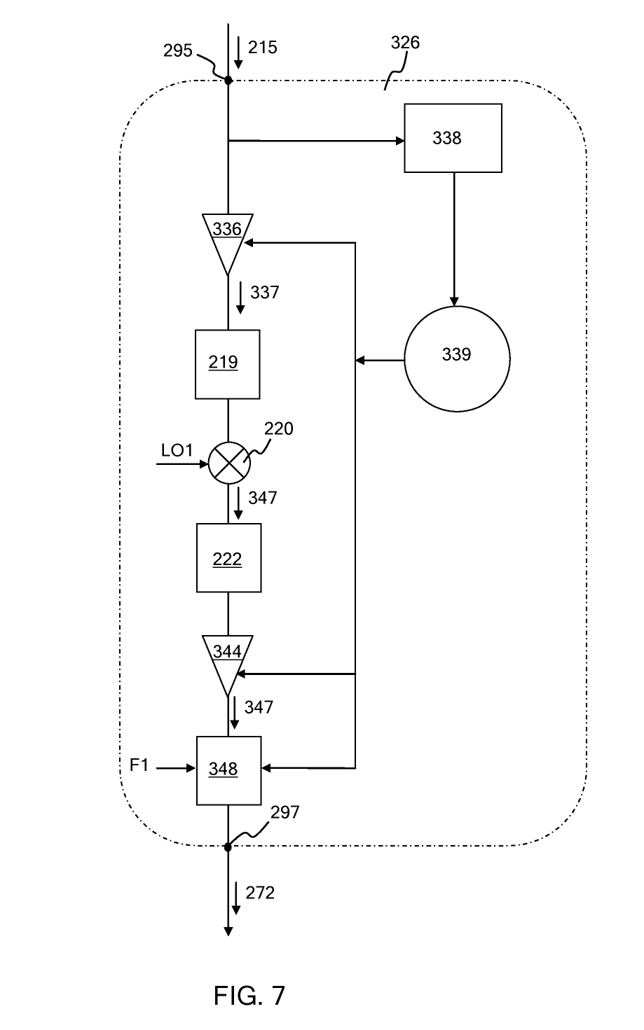

FIG. 7 shows a simplified schematic drawing of a signal transmission path 326. Signal transmission path 326 can be used in place of signal transmission path 226 of FIG. 6, for example, but this is not mean to be limiting. Signal transmission path 326 can be used in many different places in GNSS device 204 and analog signal conditioning circuit 202.

In the embodiment shown in FIG. 7, signal transmission path 326 is used in analog signal conditioning circuit 202 of FIG. 5 and FIG. 6, in place of signal transmission path 226 of FIG. 6. Signal transmission path 326 of analog signal conditioning circuit 202 conducts GNSS satellite signals 215 from input node 295 to output node 297 through the electrical components of signal transmission path 326. Digitized GNSS satellite signals 215 are output from ADC circuit 348, and are labeled 272 in FIG. 5, FIG. 6, and FIG. 7. Signal transmission path 326 is similar to signal transmission path 226 and includes some of the same components.

Signal transmission path 326 includes variable gain amplifiers 336 and 344, analog bandpass filters 219 and 222, frequency mixer 220, and analog-to-digital converter circuit 348. Signal transmission path 326 also includes interference detector circuit 338 and bias control circuit 339. Variable gain amplifier (VGA) 336 is electrically coupled to input node 295, and receives GNSS satellite signals 215 in the first frequency range from antenna 208 and signal splitting circuit 232, through first input node 295, and outputs amplified GNSS satellite signals 337 in the first frequency range. GNSS satellite signals 337 are amplified GNSS satellite signals 215. Bandpass filter 219 is electrically coupled to input node 295 through variable gain amplifier 336, and receives GNSS satellite signals 337 from variable gain amplifier 336. Bandpass filter 219 filters amplified GNSS satellite signals 337 in the first frequency range, passing GNSS satellite signals 337 in the first frequency range, and blocking other frequencies. Frequency mixer 220 is electrically coupled to bandpass filter 219 and receives filtered GNSS satellite signals 337 in the first frequency from bandpass filter 219, and outputs analog GNSS satellite signals 347 in the third frequency range in response. Frequency mixer 220 shifts the frequency of filtered GNSS satellite signals 337 from a first frequency in the first frequency range to a second frequency in the third frequency range, in this embodiment. GNSS satellite signals 337 that are frequency-shifted are labeled GNSS satellite signals 347 in FIG. 7. In this embodiment, frequency mixer 220 downconverts the frequency of GNSS satellite signals 337. In other words, the second frequency is less than the first frequency, the third frequency range is a frequency range lower than the first frequency range, and GNSS satellite signals 347 have a lower frequency than GNSS satellite signals 337.

Bandpass filter 222 is electrically coupled to frequency shifter 220 and receives GNSS satellite signals 347 in the third frequency range from frequency shifter 220. Bandpass filter 222 performs further analog filtering on GNSS satellite signals 347, passing frequency-shifted GNSS satellite signals 347 in the third frequency range, and blocking signals of other frequencies. Variable gain amplifier (VGA) 344 is electrically coupled to bandpass filter 222, and receives GNSS satellite signals 347 from bandpass filter 222. ADC 348 is electrically coupled to VGA 344 and receives GNSS satellite signals 337 from VGA 344. ADC circuit 348 digitizes GNSS satellite signals 347 and frequency-shifts GNSS satellite signal 347, as described earlier with regard to ADC 48a,b of FIG. 3. ADC circuit 348 receives analog GNSS satellite signals 347 in the third frequency range, and outputs digital GNSS satellite signals 272 in the fourth frequency range in response. In this embodiment the fourth frequency range is lower than the third frequency range. Digitized and twice frequency-shifted (once by mixer 220 and once by ADC 348) GNSS satellite signals 215, labeled GNSS satellite signals 272, exit analog signal conditioning circuit 202 at output node 297. GNSS satellite signals 272 are conducted from output node 297 to digital signal conditioning circuit 212.

Signal transmission path 326 includes interference detector circuit 338. Interference detector circuit 338 compares the power level of received signals 215 against the background noise of the signals as they enter signal transmission path 326. Interference detector circuit 338 uses the detected power level of the background noise to determine when there are interfering signals present. In some embodiments, interfering signals are determined to be present when the power level of the background noise is higher than a predetermined threshold power level. In some embodiments, interfering signals are detected using other methods. When interfering signals are detected, bias control circuit 339 adjusts the bias current of amplifiers 336 and 344, and the number of digitization bits of ADC circuit 348, to counteract the effects of the interfering signals. In this embodiment, ADC 348 is a variable bit ADC. In a signal environment free from interfering signals, GNSS device 204 yields acceptable performance with a two-bit digital output from ADC 348. However, when GNSS device 204 is in an interfering environment, interfering signals and the resulting background noise have a high power level, and this high power level of interfering signals will force amplifiers 336 and 344 into a lower gain state. When this occurs, increasing the number of bits of the ADC output will act to keep GNSS satellite signals 347 from being pushed beneath the quantization noise floor of ADC 348. In addition, increasing the bias current of AGCs 336 and 344 ensures that the one decibel compression point of GNSS device 204 is increased in response to the interfering signals. Thus, interference detector circuit 338 and bias control circuit 339 provide circuit corrections that counteract the effect of the interfering signals. When the power level of the interfering signals detected by interference detector circuit 338 is above a predetermined threshold power level, interference detector circuit 338 causes bias control circuit 339 to increase a bias current of amplifier 336, or amplifier 344, or both amplifier 336 and 344, in response. When the power level of the interfering signals detected by interference detector circuit 338 is above the predetermined threshold power level, interference detector circuit 338 causes bias control circuit 339 to increase the number of digitization bits of ADC 348 in response. Thus signal transmission path 326 includes interference detector circuit 338 and bias control circuit 339, which mitigate the effects of interfering signals on the performance of ADC 348, analog signal conditioning circuit 202, and GNSS device 204.

Referring concurrently to FIG. 5 and FIG. 8, FIG. 8 shows a block diagram of a portion of an embodiment of digital signal conditioning circuit 212 of FIG. 5 and FIG. 8. Digital signal conditioning circuit 212 is electrically coupled to analog signal conditioning circuit 202, and receives digitized GNSS satellite signals 272 and 273 from analog signal conditioning circuit 202. Digital signal conditioning circuit 212 digitally processes GNSS satellite signals 272 and 273, and outputs digitally processed signals 223 and 224 in response.

Digital signal conditioning circuit 212 includes a digital channelizer. A portion 362 of the digital channelizer is shown in FIG. 8. A digital channelizer as used herein is an electrical circuit that divides an input digital signal into a plurality of subsets of the input digital signal, where each subset is conducted through its own chain, or channel, of signal processing/filtering circuitry. In some digital channelizers, the input signal is divided multiple times into subsets.

In the illustrated embodiment, digital channelizer portion 362 is the portion of the digital channelizer of digital signal conditioning circuit 212 that channelizes GNSS satellite signal 272. “Channelizes” as used herein means to divide a signal into multiple subsets and conduct each subset through a parallel signal processing channel, in this case parallel digital signal processing channels. Only portion 362 is shown in FIG. 8 for clarity, but it is to be understood that digital signal conditioning circuit 212 includes a further portion of the digital channelizer that channelizes and processes GNSS satellite signals 273, and can contain other digital channelizer portions in some embodiments. Portion 362 includes digital signal processing channels 374 and 375 as shown in FIG. 8. Digital channelizer portion 362 channelizes and processes GNSS satellite signals 272. Digital channelizer portion 362 receives GNSS satellite signals 272 and outputs signals 223 in response, where signals 223 is the output of plurality of correlator circuits 390 and 391. Digital channelizer portion 362 receives GNSS satellite signals 272 and divides GNSS satellite signals 272 into subset 376 of GNSS satellite signals 272, and subset 377 of GNSS satellite signals 272. Digital signal processing channel 374 receives subset 376 of GNSS satellite signals 272. Channel 375 receives subset 377 of GNSS satellite signals 272.

Digital signal processing channel 374 includes a digital mixer circuit 378, a digital bandpass filter 380, a downsampler circuit 382, a requantizer circuit 384, and plurality of correlator circuits 390. Plurality of correlator circuits 390 includes correlator 392, correlator 393, and additional correlator circuits not shown for simplicity. Digital mixer circuit 378 receives subset 376 of GNSS satellite signals 272, and shifts the frequency of subset 376 of GNSS satellite signals 272. Changing the frequency of subset 376 of GNSS satellite signals 272 for processing allows digital signal conditioning circuit 212 to isolate the desired GNSS satellite signals 272 from other nearby signals and minimize the cost, size, bandwidth, and power consumption of GNSS device 204. Digital filter 380 passes the frequency band that includes the frequency-shifted subset 376 of GNSS satellite signals 272, and blocks other frequencies. In some embodiments, digital filter 380 has a programmable passband. In some embodiments, each of the digital filters included in digital signal conditioning circuit 212 have a programmable passband. Using digital filters with programmable passbands allows GNSS device 204 to be programmed to capture different frequency bands at different times, depending on the needs of the application.

Downsampler circuit 382 and requantizer circuit 384 adjust the sampling of the frequency-shifted subset 376 of GNSS satellite signal 272. Downsampling and requantizing optimize the sampling of subset 376 of GNSS satellite signals 272, in order to obtain a maximum amount of information with a minimum frequency bandwidth. Downsampling as used herein means to reduce the sampling frequency of the signal. Frequency shifted, downsampled, and requantized subset 376 of GNSS satellite signal 272 is then divided into further subsets 386, 387, and additional subsets (not shown for simplicity of FIG. 8). Each subset 386, 387, and others not shown, are conducted through one of plurality of correlator circuits 390, which includes correlator circuit 392, correlator circuit 393, and other correlator circuits not shown for simplicity.

Digital signal processing channel 375 includes a digital mixer circuit 379, a digital bandpass filter 381, a downsampler circuit 383, a requantizer circuit 385, and plurality of correlator circuits 391. Plurality of correlator circuits 391 includes a correlator circuit 394, a correlator circuit 395, and additional correlator circuits not shown for simplicity. Digital signal processing channel 375 channelizes and processes portion 377 of GNSS satellite signals 272, as explained earlier for channel 374.

The collective outputs of plurality of correlator circuits 390 and plurality of correlator circuits 391 comprise correlated signals 223, which are conducted to GNSS solution processor 214 for GNSS processing such as location determination, attitude determination, or other GNSS computations.

Digital signal conditioning circuit 212 as described herein divides digitized GNSS satellite signals 272 into a plurality of subsets of digitized GNSS satellite signal 272. The subsets of digitized GNSS satellite signal 272 includes subsets 376, 377, 386, 387, 388, and 389. Each of subsets 386, 387, 388, and 389 are conducted through a respective correlator circuit 392, 393, 394, and 395. The plurality of correlator outputs 223 of each of the plurality of correlator circuits 390 and 391 are conducted to GNSS solution processor 214.

GNSS satellite signal 273 is conducted through a similar channelizer portion by digital signal conditioning circuit 212, which detail is not shown for simplicity of FIG. 8. Digital signal conditioning circuit 212 as described herein divides digitized GNSS satellite signals 273 into a plurality of subsets of digitized GNSS satellite signal 273. Each of the subsets of digitized GNSS satellite signals 273 are conducted through one of a plurality of correlator circuits. The outputs 224 (FIG. 5) of each of the plurality of correlator circuits are conducted to GNSS solution processor 214.

It is to be understood that digital signal conditioning circuit 212 can have other components, elements, signal paths, and connections in some embodiments.

Referring particularly to FIG. 5, analog signal conditioning circuit 202 and digital signal conditioning circuit 212 perform signal filtering, frequency shifting, digitization, and channelization in order to capture and clean the GNSS signals of interest and/or other signals of interest, and deliver them to GNSS solution processor 214. Analog signal conditioning circuit 202 and digital signal conditioning circuit 212 divide the signal filtering and processing of RF signals 215, and 216 among the analog domain and the digital domain in order to minimize power consumption and physical size of GNSS device 204, and to maximize the noise filtering capabilities of GNSS device 104. GNSS solution processor 214 receives signals 223 and 224 from digital signal conditioning circuit 212, and performs GNSS processing on signals 223 and 224 to compute GNSS location, GNSS attitude, and perform any other desired GNSS calculations. The GNSS location, attitude and other GNSS calculations are precise because GNSS device 204 has captured and isolated GNSS satellite signals 215 and 216, creating clean signals 223 and 224, without interference from nearby out-of-band signals or other undesirable frequencies.

FIG. 9 shows a block diagram of an embodiment of GNSS device 404. GNSS device 404 is similar to GNSS device 204 of FIG. 5, except that GNSS device 404 divides the RF signals 405 received into three initial portions as compared to two for GNSS device 204. It is to be understood that GNSS device 204 and 404 can, in some embodiments, divide the received RF signals into two, three, four, or more portions of the received RF signals. GNSS device 404 captures and processes GNSS satellite signals from one or more GNSS satellite constellations, as well as other RF signals of interest, as shown with GNSS device 104 in FIG. 1. In this embodiment, GNSS device 404 is used in place of GNSS device 104 in FIG. 1.

GNSS device 404 receives RF signals 405 with at least one antenna, which in the embodiment shown in FIG. 9 is antenna 408. RF signals 405 can include any or all of the RF signals shown in FIG. 1, as well as other RF signals of any type and frequency. For example, GNSS device 404 in this embodiment receives a plurality of GNSS satellite signals 184 from GNSS constellation 100, and a plurality of GNSS satellite signals 185 from GNSS constellation 101, as shown in FIG. 1. In some embodiments, GNSS device 404 receives pluralities of GNSS satellite signals from more than two GNSS constellations. GNSS device 404 also receives cellular telephone signals 190, wanted RF signals 192 and unwanted RF signals 193, as shown for GNSS device 104 in FIG. 1.

GNSS device 404 includes a signal splitting circuit 432, an analog signal conditioning circuit 402, a digital signal conditioning circuit 412, and a GNSS solutions processor 414. Antenna 408 captures RF signals 405 and conducts RF signals 405 to signal splitting circuit 432. In some embodiments, signal splitting circuit 432 is a LNA circuit. Signal splitting circuit 432 includes three bandpass filters, a bandpass filter 429, a bandpass filter 430, and a bandpass filter 431.

Each bandpass filter 429, 430, and 431 of signal splitting circuit 432 passes a band of RF signals, and blocks signals outside its passband, as explained for signal splitting circuit 232 except for the fact that the present embodiment employs three passband filters. Thus, signals outside the passbands of bandpass filters 429, 430, and 431 are blocked from reaching GNSS receiver 409.

Signal splitting circuit 432 receives RF signals 405 from antenna 408, and outputs RF signals 415, 416, and 417. In this embodiment, bandpass filters 429, 430, and 431 receive RF signals 405 from antenna 408, pass RF signals 415, 416, and 417 in a first frequency range, a second frequency range, and a third frequency range respectively in response, and reject signals of other frequencies. RF signals 415 in the first frequency range, RF signals 416 in the second frequency range, and RF signals 417 in the third frequency range are conducted to analog signal conditioning circuit 402 of GNSS receiver 409. RF signals 415, 416, and 417 can be GNSS satellite signals, cellular telephone signals, INMARSAT signals, GNSS correction service signals, or other RF signals of interest. In the embodiment of GNSS device shown in FIG. 9, the first frequency range is from about 1553 megahertz (MHz) to about 1609 MHz, the second frequency range is from about 1217 MHz to about 1289 MHz, and the third frequency range is from about 1165 MHz to about 1217 MHz. In some embodiment the first, second, or third frequency ranges are other frequency ranges.

Analog signal conditioning circuit 402 and digital signal conditioning circuit 412 perform signal filtering, frequency shifting, digitization, and channelization in order to capture and clean the GNSS signals of interest and/or other RF signals of interest, and deliver them to GNSS solution processor 414. GNSS solution processor 414 performs GNSS computations such as location determination and attitude determination, as well as other GNSS computations.

Referring concurrently to FIG. 9 and FIG. 10, FIG. 10 shows a simplified block diagram of one example embodiment of analog signal conditioning circuit 402 of FIG. 9. Analog signal conditioning circuit 402 includes a plurality of signal filtering/processing channels. In this embodiment analog signal conditioning circuit 402 includes three signal processing and filtering channels 426, 427, and 418, but this is not meant to be limiting. In this embodiment channels 426, 427, and 418 are each similar to signal processing and filtering channel 226 described earlier. GNSS satellite signals 415, 416, and 417 received at analog signal conditioning circuit 402 from signal splitting circuit 432 are the GNSS satellite signal sub-bands subdivided from RF satellite signal 405 by signal splitting circuit 432. Analog signal conditioning circuit 402 digitizes each of GNSS satellite signals 415, 416, and 417 before they are conducted to digital signal conditioning circuit 412.

Analog signal conditioning circuit 402 conducts GNSS satellite signals 415 through signal filtering/processing channel 426 comprising VGAs 436 and 444, analog bandpass filters 419 and 422, frequency mixer 420, and analog-to-digital converter 448. VGAs 436 and 444 provide a distributed and adjustable amount of gain to GNSS satellite signals 415. Bandpass filters 419 and 422 block undesirable frequencies from passing through channel 426. Frequency mixer 420 shifts the frequency of GNSS satellite signals 415. In this embodiment, frequency mixer 420 downconverts the frequency of GNSS satellite signals 415. Shifting the frequency provides for moving GNSS satellite signals 415 away from interfering frequencies, as well as minimizing the power consumption of the signal processing elements. ADC 448 digitizes GNSS satellite signal 415, as well as performing a second downconversion on GNSS satellite signals 415.

Analog signal conditioning circuit 402 conducts GNSS satellite signals 416 and 417 through parallel signal filtering/processing channels 427 and 418, which are similar to channel 426. Analog signal conditioning circuit 402 conducts GNSS satellite signals 416 through signal filtering/processing channel 427 comprising VGA 437 and 445, analog bandpass filters 421 and 492, frequency mixer 479, and analog-to-digital converter 449. GNSS satellite signals 417 are conducted through signal filtering/processing channel 418 comprising VGAs 438 and 443, analog bandpass filters 491 and 493, frequency mixer 480, and analog-to-digital converter 451. Analog signal conditioning circuit 202 also includes a frequency synthesizer 450 and a crystal oscillator 428. Frequency synthesizer 450 receives a clock signal from crystal oscillator 428, which it uses to create clock frequency signals LO1, LO2, and LO3 for frequency mixers 420, 479, and 480 respectively, and frequency signals F1, F2, and F3, for ADC circuits 448, 449, and 451.

Each of GNSS satellite signals 415, 416, and 417 are filtered, shifted in frequency twice (once by mixers 420, 479, and 480, and once by ADCs 448, 449, and 451), and digitized by analog signal conditioning circuit 402. In this embodiment all the frequency shifting downconverts the signal frequencies to lower frequencies. Filtered, downconverted, and digitized GNSS satellite signals 415 are labeled 472 in FIG. 9 and FIG. 10, and are conducted to digital signal conditioning circuit 412 for digital signal filtering/processing. Filtered, downconverted, and digitized GNSS satellite signals 416 are labeled 473 in FIG. 9 and FIG. 10, and are conducted to digital signal conditioning circuit 412 for digital signal filtering/processing. Filtered, downconverted, and digitized GNSS satellite signals 417 are labeled 474 in FIG. 9 and FIG. 10, and are conducted to digital signal conditioning circuit 414 for digital signal filtering/processing.

Signal processing channels 426, 427, and 418 can include many different configurations. Signal processing channels 426, 427, or 418 can be the same or similar to signal processing channels 18a or 18b of FIG. 3, or channel 227 of FIG. 6, or channel 326 of FIG. 7, for example but not by way of limitation.

Digital signal conditioning circuit 412 is electrically coupled to analog signal conditioning circuit 402, and receives digitized GNSS satellite signals 472, 473, and 474 from analog signal conditioning circuit 402. Digital signal conditioning circuit 412 further digitally processes GNSS satellite signals 472, 473, and 474, and outputs digitally processed signals 423, 424, and 425 in response.

Digital signal conditioning circuit 412 in this embodiment includes a digital channelizer, similar to digital signal conditioning circuit 212 of FIG. 8. Digital signal conditioning circuit 412 channelizes, processes, subdivides, and correlates GNSS signals 472, 473, and 474, and outputs correlator outputs signals 423, 424, and 425 in response. Signals 423, 424, and 425 are conducted to GNSS solution processor 414 for GNSS processing such as location determination, attitude determination, or other GNSS computations.

Referring again to FIG. 9, analog signal conditioning circuit 402 and digital signal conditioning circuit 412 perform signal filtering, frequency shifting, digitization, and channelization in order to capture and clean the GNSS signals of interest and/or other signals of interest, and deliver them to GNSS solution processor 414. Analog signal conditioning circuit 402 and digital signal conditioning circuit 412 divide the signal filtering and processing of RF signals 415, 416, and 417 among the analog domain and the digital domain in order to minimize power consumption and physical size of GNSS device 404, and to maximize the noise filtering capabilities of GNSS device 404. GNSS solution processor 414 receives signals 423, 424, and 425 from digital signal conditioning circuit 412, and performs GNSS processing on signals 423, 424, and 425 to compute GNSS location, GNSS attitude, and perform any other desired GNSS calculations. The GNSS location, attitude and other GNSS calculations are precise because GNSS device 404 has captured and isolated GNSS satellite signals 415, 416, and 417, creating clean signals 423, 424, and 425, without interference from nearby out-of-band signals or other undesirable frequencies.

FIG. 11 illustrates method 500 of processing RF signals received by a GNSS device. Method 500 includes element 510 of conducting a first portion of RF signals received by an antenna through a first analog filter, wherein the first analog filter passes GNSS satellite signals in a first frequency range and rejects signals of other frequencies. Method 500 of processing RF signals received by a GNSS device also includes element 520 of digitizing the GNSS satellite signals passed through the first analog filter. In some embodiments, an ADC circuit is used to digitize the GNSS satellite signals.

Method 500 of processing RF signals received by a GNSS device also includes element 530 of conducting a second portion of the RF signals received by the antenna through a second analog filter, wherein the second analog filter passes RF signals in a second frequency range and rejects signals of other frequencies. Method 500 also includes element 540 of dividing the digitized GNSS satellite signals passed through the first analog filter into a plurality of subsets of the digitized GNSS satellite signals passed through the first analog filter, and element 550 of conducting each of the plurality of subsets of the digitized GNSS satellite signals passed through the first analog filter through a corresponding one of a plurality of correlator circuits.

In some embodiments, the GNSS satellite signals passed through the first analog filter circuit include GNSS satellite signals from at least two GNSS constellations. In some embodiments, the GNSS satellite signals passed through the first analog filter circuit include GNSS satellite signals from at least three GNSS constellations. In some embodiments, the GNSS satellite signals passed through the first analog filter circuit include GNSS satellite signals from more than three GNSS constellations. In some embodiments, the second portion of the RF signals includes GNSS satellite signals in the second frequency range from at least two GNSS constellations. In some embodiments, the second portion of the RF signals includes GNSS satellite signals in the second frequency range from more than two GNSS constellations.

Method 500 can include many other elements. In some embodiments, method 500 includes digitally filtering each one of the plurality of subsets of the digitized GNSS satellite signals passed through the first analog filter with a corresponding one of a plurality of digital filters, wherein each of the plurality of digital filters has a programmable passband. In some embodiments, method 500 includes downsampling each of the digitally filtered plurality of subsets of the digitized GNSS satellite signals before correlation. In some embodiments, method 500 includes re-quantizing each of the downsampled plurality of subsets of the digitized GNSS satellite signals before correlation.

In some embodiments, method 500 includes amplifying the first portion of the RF signals with a first amplifier. In some embodiments, method 500 includes shifting the frequency of the amplified first portion of the RF signals from a first frequency in the first frequency range to a second frequency. In some embodiments, method 500 includes amplifying the RF signals of the second frequency with a second amplifier. In some embodiments, method 500 includes detecting a power level of the first portion of the RF signals. In some embodiments, method 500 includes increasing a bias current of the first and the second amplifier in response to a detected power level of the first portion of the RF signals being greater than a predetermined threshold power level. In some embodiments, method 500 includes increasing a number of bits of the analog-to-digital converter in response to the detected power level of the first portion of the RF signals being greater than a predetermined threshold power level.

In some embodiments, element 520 of digitizing the GNSS satellite signals passed through the first analog filter includes shifting the frequency of the RF signals of the second frequency from the second frequency to a third frequency using the analog-to-digital converter. In some embodiments, the third frequency is less than the second frequency and the second frequency is less than the first frequency.

In some embodiments, element 550 of conducting each of the plurality of subsets of the digitized GNSS satellite signals through a corresponding one of a plurality of correlator circuits includes subdividing each of the re-quantized plurality of subsets of the GNSS satellite signals into a plurality of re-quantized GNSS satellite signals. In some embodiments, element 500 of conducting each of the plurality of subsets of the digitized GNSS satellite signals through a corresponding one of a plurality of correlator circuits includes conducting each one of the plurality of re-quantized GNSS satellite signals through a corresponding one of a plurality of correlator circuits.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above.

1. A global navigation satellite system (GNSS) device comprising:
at least one antenna, wherein the at least one antenna receives RF signals, and wherein the RF signals comprise GNSS satellite signals;
an analog signal conditioning circuit, wherein the analog signal conditioning circuit receives the GNSS satellite signals from the antenna, and wherein the analog signal conditioning circuit digitizes at least a portion of the GNSS satellite signals received from the antenna;
a digital signal conditioning circuit electrically coupled to the analog signal conditioning circuit, wherein the digital signal conditioning circuit comprises:
a digital channelizer, wherein the digital channelizer conducts digitized GNSS satellite signals received from the analog signal conditioning circuit through a plurality of parallel digital signal processing channels;
and
a plurality of correlator circuits, wherein each of the plurality of correlator circuits receives a portion of the digitized GNSS satellite signals from the plurality of parallel digital signal processing channels;
and
a GNSS solution processor, wherein the GNSS solution processor receives a plurality of correlator output signals from the plurality of correlator circuits.

2. The GNSS device of claim 1, wherein the analog signal conditioning circuit comprises:
a first signal transmission path comprising:
a first signal input node, wherein the first signal input node receives GNSS satellite signals from the antenna;
a first analog-to-digital converter circuit; and
a first signal output node electrically connected to the first signal input node through the first analog-to-digital converter circuit;
wherein the first signal transmission path conducts the GNSS satellite signals from the first signal input node to the first signal output node through the first analog-to-digital converter circuit;
and
a second signal transmission path comprising:
a second signal input node; wherein the second signal input node receives RF signals from the antenna;
a second signal output node electrically coupled to the second signal input node through a switch;
and
a third signal output node electrically coupled to the second signal input node through the switch.

3. The GNSS device of claim 2, wherein:
the second signal transmission path conducts the RF signals from the second signal input node to the second signal output node through a second analog-to-digital converter circuit in response to the switch being in a first position; and
the second signal transmission path conducts the RF signals from the second signal input node to the third signal output node through a frequency mixer circuit in response to the switch being in a second position.

4. The GNSS device of claim 1, wherein the analog signal conditioning circuit comprises:
a first frequency mixer circuit, wherein a first signal transmission path conducts GNSS satellite signals from a first signal input node to a first signal output node through the first frequency mixer circuit;
a second frequency mixer circuit, wherein a second signal transmission path conducts RF signals from a second signal input node to a switch through the second frequency mixer circuit;
an analog-to-digital converter circuit, wherein the second signal transmission path conducts the RF signals from the switch to a second signal output node through the analog-to-digital converter circuit in response to the switch being in a first position;
and
a third frequency mixer circuit, wherein the second signal transmission path conducts the RF signals from the switch to a third signal output node through the third frequency mixer circuit in response to the switch being in a second position.

5. The GNSS device of claim 1, wherein the analog signal conditioning circuit comprises:
an amplifier, wherein the amplifier receives analog RF signals of a first frequency from the antenna, and outputs amplified analog RF signals of the first frequency in response;
a mixer, wherein the mixer receives the amplified analog RF signals of the first frequency, and outputs analog RF signals of a second frequency in response;
and
an analog-to-digital converter circuit, wherein the analog-to-digital converter circuit receives the analog RF signals of the second frequency, and outputs digital RF signals of a third frequency in response.

6. The GNSS device of claim 5, wherein the second frequency is lower than the first frequency, and the third frequency is lower than the second frequency.

7. The GNSS device of claim 1, wherein the RF signals received by the antenna comprise GNSS satellite signals from at least two GNSS constellations.

8. The GNSS device of claim 1, wherein the RF signals received by the antenna comprise GNSS satellite signals from at least three GNSS constellations.

9. A method of processing radio frequency (RF) signals received by a global navigation satellite system (GNSS) device comprising:
conducting a first portion of RF signals received by an antenna through a first analog filter, wherein the first analog filter passes GNSS satellite signals in a first GNSS frequency range and rejects signals of other frequencies;
digitizing the GNSS satellite signals passed through the first analog filter with an analog-to-digital converter circuit;
conducting a second portion of the RF signals received by the antenna through a second analog filter, wherein the second analog filter passes RF signals in a second frequency range and rejects signals of other frequencies;
dividing the digitized GNSS satellite signals passed through the first analog filter into a plurality of subsets of the digitized GNSS satellite signals passed through the first analog filter;
and
conducting each of the plurality of subsets of the digitized GNSS satellite signals passed through the first analog filter through a corresponding one of a plurality of correlator circuits.

10. The method of claim 9, further comprising digitally filtering each one of the plurality of subsets of the digitized GNSS satellite signals passed through the first analog filter with a corresponding one of a plurality of digital filters, wherein each of the plurality of digital filters has a programmable passband.

11. The method of claim 10, further comprising downsampling each of the digitally filtered plurality of subsets of the digitized GNSS satellite signals before correlation.

12. The method of claim 11, further comprising re-quantizing each of the downsampled plurality of subsets of the digitized GNSS satellite signals before correlation.

13. The method of claim 12, wherein conducting each of the plurality of subsets of the digitized GNSS satellite signals through a corresponding one of a plurality of correlator circuits comprises:
subdividing each of the re-quantized plurality of subsets of the GNSS satellite signals into a plurality of re-quantized GNSS satellite signals;
and
conducting each one of the plurality of re-quantized GNSS satellite signals through a corresponding one of a plurality of correlator circuits.

14. The method of claim 9, wherein the GNSS satellite signals passed through the first analog filter circuit comprise GNSS satellite signals from at least two GNSS constellations.

15. The method of claim 9, wherein the GNSS satellite signals passed through the first analog filter circuit comprise GNSS satellite signals from at least three GNSS constellations.

16. The method of claim 14, wherein the second portion of the RF signals comprises GNSS satellite signals in the second frequency range from at least two GNSS constellations.

17. The method of claim 9, further comprising:
shifting the frequency of the second portion of the RF signals;
conducting the frequency-shifted second portion of the RF signals to a switch;
digitizing the frequency-shifted second portion of the RF signals in response to the switch being in a first position;
and
shifting the frequency of the frequency-shifted second portion of the RF signals a second time in response to the switch being in a second position.

18. The method of claim 17, wherein digitizing the GNSS satellite signals passed through the first analog filter comprises digitizing and frequency shifting the GNSS satellite signals passed through the first analog filter, using an analog-to-digital converter circuit.

19. The method of claim 18, wherein the third frequency is less than the second frequency and the second frequency is less than the first frequency.
